(19) United States
(12) Patent Application Publication
(10) Pub. No.: US 2014/0283925 A1
(43) Pub. Date: Sep. 25, 2014

(54) FLUIDS COLLECTION AND DRAIN SYSTEM

(71) Applicant: Matthew L Justus, Piney Flats, TN (US)

(72) Inventor: Matthew L Justus, Piney Flats, TN (US)

(21) Appl. No.: 14/215,301

(22) Filed: Mar. 17, 2014

Related U.S. Application Data
(60) Provisional application No. 61/804,037, filed on Mar. 21, 2013.

(51) Int. Cl. A61J 1/14

(52) U.S. Cl. CPC A61J 1/1443
USPC 137/312

(57) ABSTRACT

A fluids collection and drain system includes a tray and a screen. The tray has a base, a peripheral wall to include an annular ledge, at least one support coupled to the base that has a planar top at the same distance from the base as the annular ledge, and at least one drain port in the peripheral wall between the base and annular ledge. The screen has a solid annular frame surrounding a perforation region with a plurality of perforations being defined therethrough. The solid annular frame rests on the tray's annular ledge and a portion of the perforation region rests on each planar top of the support(s).

Pursuant to 35 U.S.C. §119, the benefit of priority from provisional application 61/804,037, with a filing date of Mar. 21, 2013, is claimed for this non-provisional application.

### FIELD OF THE INVENTION

The invention relates generally to surgery accessories, and more particularly to a system that provides for the collection and drainage of fluids from an operative site.

### BACKGROUND OF THE INVENTION

In emergency rooms and surgery venues, fluid handling is always a concern. Fluids can be bodily fluids or fluids introduced by health care personnel during the course of treatment. Both types of fluids must be managed to prevent patient infection, prevent patient and/or health care personnel contamination, and/or prevent slip-and-fall hazards once the fluids are on a floor. Currently, health care personnel use a variety and combination of localized suction devices and absorbable pads/mats. However, use of suction devices requires personnel to operate them, and their presence near an operative site can be a distraction to surgical personnel. The use of absorbable pads and mats must also be monitored for replacement and proper disposal or the fluid-laden pads/mats themselves become a health and safety concern.

The above-noted fluid handling problems are of greater concern in field hospital settings where casualties can be severe and numerous, health care personnel are in short supply, and surgical procedures must be performed in a “hurry up” mode. Given these realities, fluid handling in field hospital settings is frequently not given the attention it deserves. Unfortunately, problems introduced by poor fluid handling procedures in a field setting can negatively impact good surgical work.

### SUMMARY OF THE INVENTION

Accordingly, it is an object of the present invention to provide a system for collecting fluids at their point of generation.

Another object of the present invention is to provide a system that facilitates the handling of fluid generated during emergency and planned surgical procedures.

Still another object of the present invention is to provide a system that can efficiently and safely remove surgical fluids from their point of generation.

Yet another object of the present invention is to provide a system that facilitates surgical fluid collection/removal with minimal personnel involvement.

Other objects and advantages of the present invention will become more obvious hereinafter in the specification and drawings.

In accordance with the present invention, a fluids collection and drain system includes a tray having a base, a peripheral wall to include an annular ledge surrounding the base at a distance from the base, at least one support coupled to the base wherein the support has a planar top at the same distance from the base as the annular ledge, and at least one drain port defined in the peripheral wall between the base and annular ledge. The system also includes a screen having a solid annular frame surrounding a perforation region with a plurality of perforations being defined therethrough. The solid annular frame rests on the tray's annular ledge and a portion of the perforation region rests on each planar top of the support(s).

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is an exploded perspective view of a fluids collection and drain system in accordance with an embodiment of the present invention;

FIG. 2 is a cross-sectional view of the system's tray taken along line 2-2 in FIG. 1;

FIG. 3 is a cross-sectional view of the system's tray taken along line 3-3 in FIG. 1;

FIG. 4 is a cross-sectional view of the tray's drain port;

FIG. 5 is a cross-sectional view of a portion of the tray with the edge of the framed screen captured by one of the tray's retaining tabs;

FIG. 6 is a plan view of a tray having two drain ports in accordance with another embodiment of the present invention;

FIG. 7 is an isolated perspective view of a tray that includes a lanyard-coupled drain port cap in accordance with another embodiment of the present invention;

FIG. 8 is an isolated perspective view of a tray that includes a recessed peripheral base region in accordance with another embodiment of the present invention; and

FIG. 9 is a side view of a flexible strap assembly that can be included as part of the fluids collection and drain system to restrain a body part in accordance with another embodiment of the present invention.

### DETAILED DESCRIPTION OF THE INVENTION

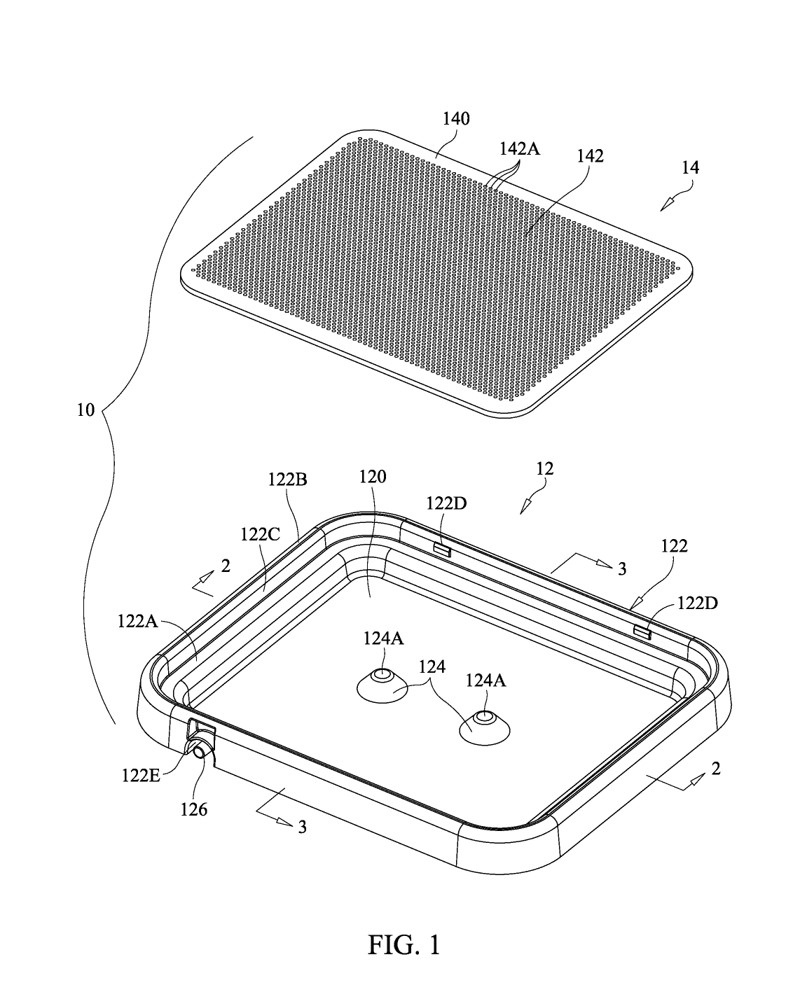

Referring now to the drawings and more particularly to FIG. 1, a fluids collection and drain system in accordance with an embodiment of the present invention is shown in exploded form and is referenced generally by numeral 10. By way of an illustrative example, system 10 will be explained for its use in the collection/drainage of surgical fluids. It is to be understood that the term “surgical” as used herein refers to invasive surgical procedures as well as topical wound treatment. Accordingly, system 10 is contemplated for use in dedicated surgical settings, emergency room settings, chronic wound care settings, burn centers, field hospital settings, and in-the-field settings encountered by first responder personnel, battlefield medics, etc. However, it is also to be understood that system 10 can be used for other types of fluids collection/drainage without departing from the scope of the present invention.

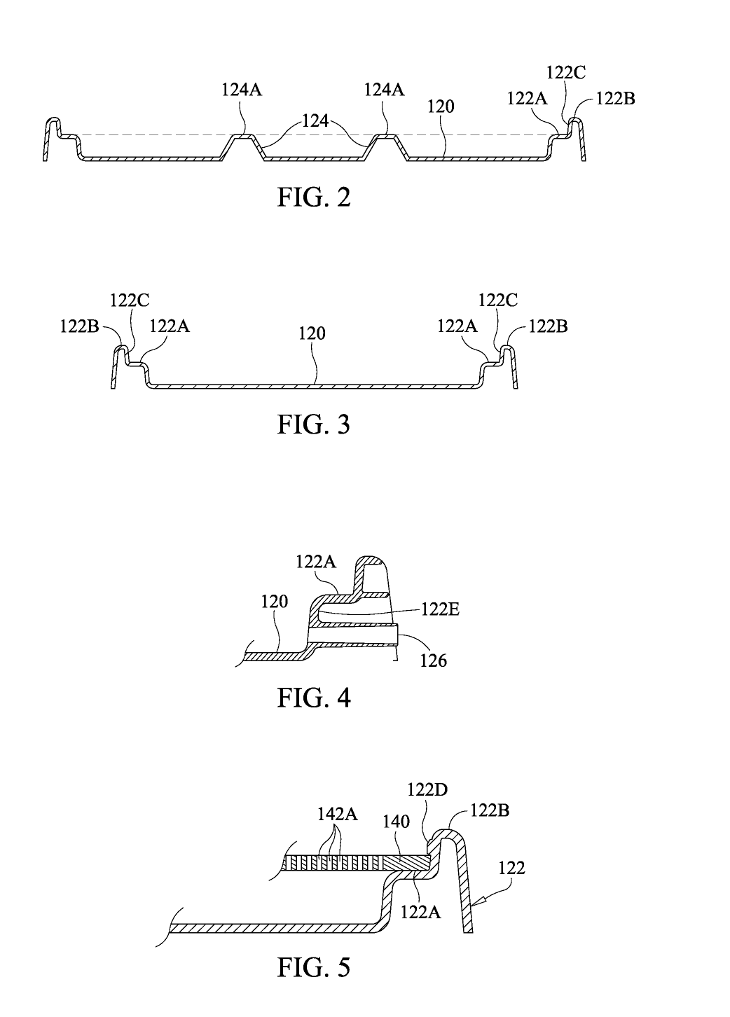

System 10 includes a tray 12 and a framed screen 14 that are assembled prior to use of system 10. Each of tray 12 and framed screen 14 can be an assembled structure, an integrated structure, or a monolithic structure, without departing from the scope of the present invention. Each of tray 12 and screen 14 can be made from a plastic, composite, metal, or combinations thereof. By way of example, each of tray 12 and screen 14 can be monolithic structures made using a material such as polyproplyene. However, it is to be understood that particular choice of material and fabrication methods for tray 12 and screen 14 are not limitations of the present invention. Tray 12 will be explained with additional reference to the various cross-sectional views thereof presented in FIGS. 2-4.

Tray 12 includes a base 120 with a continuous peripheral wall 122 formed about and integral with the periphery of base 120. The rectangular shape of tray 12 is not a limitation of the present invention as other shapes could be used without departing from the scope of the present invention. Peripheral wall 122 defines two annular lips, ledges or steps 122A and 122B. The lower annular step 122A defines an annular ledge on which framed screen 14 will rest at a distance above base 120 as will be described further below. The upper annular step 122B defines an annular top of tray 12 that is above framed screen 14 when screen 14 is assembled with tray 12. A vertical “kickplate” region 122C of wall 122 between steps 122A and 122B has a number of retaining tabs 122D incorporated/integrated therewith that retain framed screen 14 in tray 12 as will be explained further below.

Integrated with base 120 are one or more (e.g., two are shown in the illustrated embodiment) truncated cone supports 124. In the illustrated embodiment, each of supports 124 is a right circular cone truncated to define a planar top 124A that is aligned vertically with annular step 122A as best seen in FIG. 2. The combination of a one-piece tray 12, the continuous structure of annular step 122A, and planar tops 124A, forms a stable support for framed screen 14 when screen 14 is assembled to tray 12. Such stable support is critical to health care personnel performing delicate procedures and is critical for patient comfort when system 10 is positioned under a body part/region. In addition to its contribution to a stable base for screen 14, the conical shape of supports 124 facilitates fluid flow (impinging thereon after passing through framed screen 14) to base 120.

Formed in peripheral wall 122 is at least one elongated drain port 126. More specifically, a recessed region 122E is formed in an outer portion of wall 122 with drain port 126 integrated with and extending through recessed region 122E. In this way, a siphon or suction tube (not shown) can be readily coupled to drain port 126. That is, a tube coupled to drain port 126 can be used to siphon fluid from tray 12 via gravity or using some type of suction device. Such siphon/suction tubes and suction devices used therewith are well known in the art.

Framed screen 14 is a monolithic structure defined by a solid annular frame region 140 that circumvents a screen region 142 having a number of perforations 142A extending therethrough. Annular frame region 140 provides rigidity for framed screen 14. While the exact size of perforations 142A is not a limitation of the present invention, they generally should be smaller than the diameter of drain port 126. In this way, solid particles/objects (e.g., dressings, blood clots, bone fragments, body tissue fragments, etc.) will not fall into tray 12 where they could clog drain port 126.

As mentioned above, prior to using system 10, framed screen 14 is assembled to tray 12. The relationship of framed screen 14 to tray 12 is illustrated in the cross-sectional view of FIG. 5. Frame region 140 is pressed into place and comes to rest on annular step 122A. Retaining tabs 122D capture frame region 140 against annular step 122A. This mounting configuration in combination with supports 124 fixes framed screen 14 in tray 12 and provides a stable base when system 10 is placed beneath a body part/region being treated.

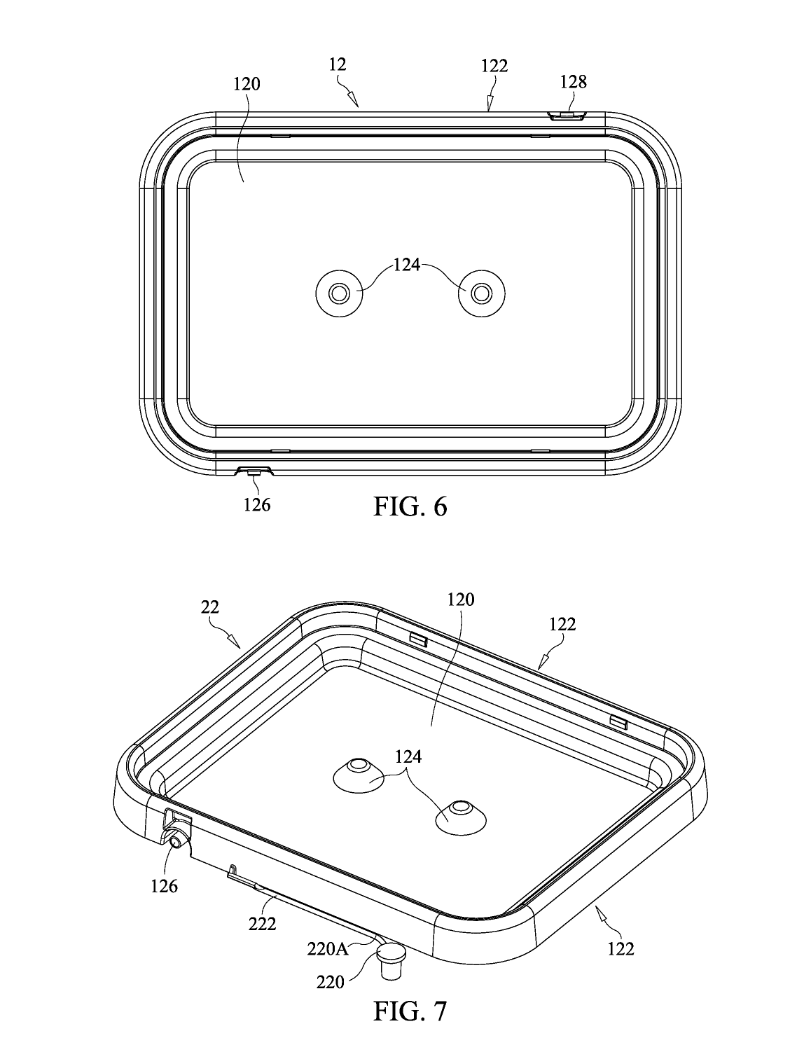

Referring now to FIG. 6, another embodiment of a tray for use in the collection and drain system is illustrated. In this embodiment, a second drain port 128 is provided in peripheral wall 122 on the side of tray 12 that is opposite the side thereof supporting drain port 126. This will increase the volume of fluids that can be removed from tray 12 in cases where there is excessive fluid generation. Further, the additional drain port will virtually eliminate any need to re-position system 10 under a patient in order to access a drain port. As a result, operative procedures can be implemented more efficiently with minimal patient disturbance.

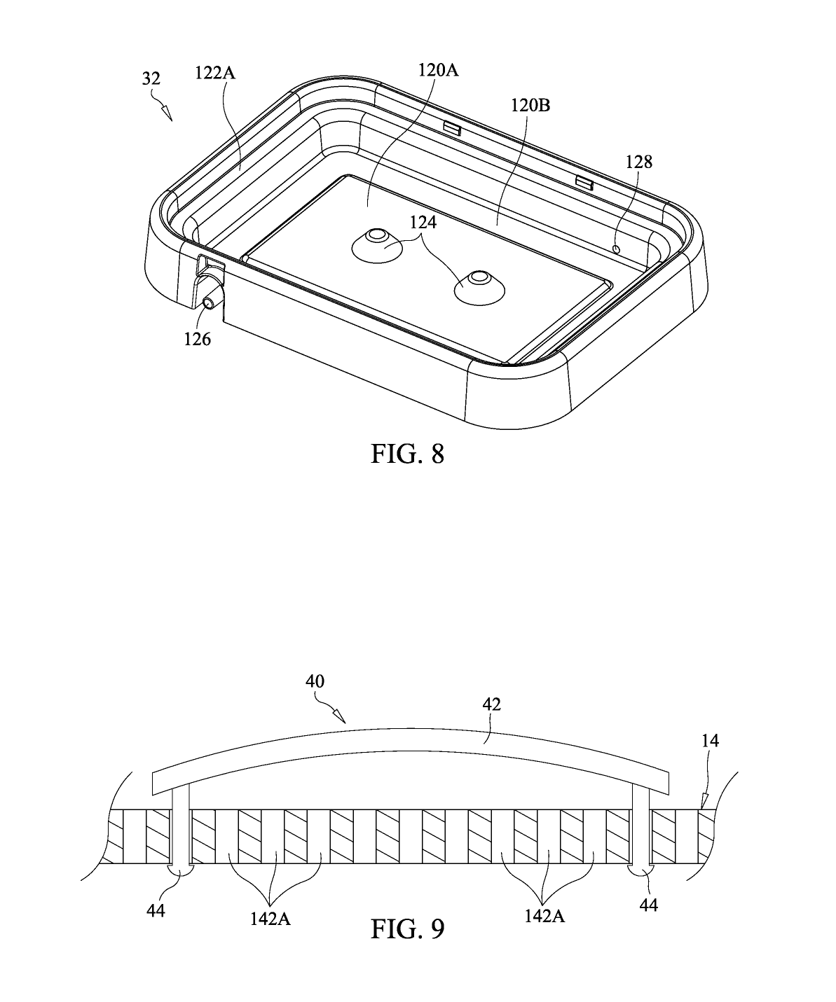

Referring now to FIG. 7, another embodiment of a tray that can be used in the present invention is shown and is referenced generally by numeral 22. Tray 22 is similar to tray 12 described above, and further includes a cap 220 (or plug) that can be used to seal drain port 126. In the illustrated embodiment, a flexible lanyard 222 is coupled on one end thereof to peripheral wall 122 and coupled on the other end thereof to cap 220. When tray 22 is a monolithic/molded product, lanyard 222 and cap 220 could be molded along with tray 22. For example, one end of lanyard 222 could be integrated with wall 122 and cap 220 could be integrated with the other end of lanyard 222. Cap 220 could be attached to peripheral wall 122 by a “snap away” region 220A designed to fail/break when cap 220 is needed to seal drain port 126. Note that if multiple drain ports are provided in the tray, a separate cap-and-lanyard would be provided for each drain port. In this way, a single drain port can be readily selected for drainage while the second one is capped. The integration of the cap and lanyard means that health care personnel do not need to search for and/or fumble with loose parts.

Still another embodiment of a tray that can be used in the present invention is shown in FIG. 8 and is referenced generally by numeral 32. Tray 32 is similar to tray 12 illustrated in FIG. 6 except that base 120 (FIG. 6) is defined by a central region 120A supporting and surrounding cone supports 124, and a peripheral region 120B surrounding central region 120A and extending to peripheral wall 122. Base region 120A forms the base for cone supports 124 whose planar tops 124A are aligned with annular ledge 122A. Peripheral region 120B defines a floor region of the base that is below the lowermost portion of drain ports 126 and 128, i.e., the distance from peripheral region 120B to annular ledge 122A is greater than the distance from central region 120A to annular ledge 122A. In this way, small solids that get through perforations 142A in screen 14 will collect in peripheral region 120B and will not enter/clog drain ports 126 and 128.

As mentioned above, the fluids collection and drain system of the present invention can be used in a support role for a limb or body part being treated. To restrict movement of the limb or body part being treated to thereby assure good patient care and efficient fluid collection, the system of the present invention can include one or more restraining straps designed to cooperate with screen 14. For example, FIG. 9 illustrates one such restraining strap assembly 40 coupled to a screen 14. Strap assembly 40 includes a flexible strip 42 of material (e.g., plastic, metal, etc.) with couplers 44 (e.g., capped studs as shown) at either end thereof. In use, each of capped studs 44 cooperates with one of the perforations 142A of screen 14 as flexible strip 42 extends over the limb or body part (not shown) supported on the screen to thereby restrict movement of the limb or body part. The length of flexible strip 42 and/or the positioning of capped studs 44 can be adjustable or set to specific lengths without departing form the scope of the present invention. At the conclusion of treatment, flexible strip 42 can simply be cut.

The advantages of the present invention are numerous. For surgical applications, the assembled fluid collection and drain system is placed under a body part/portion receiving treatment. If necessary or desired, the body part's movement can be restricted using one or more of the above-described retraining straps. Body and treatment fluids are readily captured in the one-piece tray and are readily drained, siphoned and/or suctioned therefrom. The framed screen is well supported by the design of the screen in combination with the support therefor provided by the tray's annular ledge and base support(s). Non-fluid refuse, clots, bone matter, soft tissue, etc., are captured on the screen (and, optionally, in the tray's peripheral base region) to prevent drain clogs. Once the system is in position, no monitoring personnel are required for its operation and its use will last for an entire treatment process. When caps are provided, the drain ports can be sealed so that any fluid remaining in the tray does not spill out when the system is removed from a treatment area.

The fluid collection and drain system reduces personnel costs, promotes safe working conditions during and after treatment, and provides a stable support for a treated body part/portion thereby improving patient care. The system of the present invention achieves all of these benefits with a simple assembly that can readily be introduced into surgical settings, emergency room settings, chronic wound care settings, burn centers, field hospital settings, and first-responder type field settings.

Although the invention has been described relative to a specific embodiment thereof, there are numerous variations and modifications that will be readily apparent to those skilled in the art in light of the above teachings. For example, other uses of the present invention could include industrial applications (e.g., parts washing, oil/fluid collection, etc.) requiring size and/or material changes to support the particular application without departing from the scope of the present invention. It is therefore to be understood that, within the scope of the appended claims, the invention may be practiced other than as specifically described.

What is claimed as new and desired to be secured by Letters Patent of the United States is:

1. A fluids collection and drain system, comprising:
a tray having a base, a peripheral wall to include an annular ledge surrounding said base at a distance from said base, at least one support coupled to said base wherein said support has a planar top at said distance from said base, and at least one drain port defined in said peripheral wall between said base and said annular ledge; and
a screen having a solid annular frame surrounding a perforation region having a plurality of perforations defined therethrough, wherein said solid annular frame rests on said annular ledge and a portion of said perforation region rests on each said planar top.

2. A fluids collection and drain system as in claim 1, further comprising a plurality of tabs defined in and distributed about said peripheral wall above said annular ledge for engaging said solid annular frame of said screen.

3. A fluids collection and drain system as in claim 1, further comprising:
a flexible lanyard coupled on one end thereof to an outside edge of said peripheral wall; and
a cap coupled to another end of said lanyard wherein said cap is sized for sealing engagement with said drain port.

4. A fluids collection and drain system as in claim 1, wherein said base comprises:
a first base region surrounding said at least one support at said distance from said annular ledge; and
a second base region surrounding said first base region and extending to said peripheral wall, said second base region at a second distance from said annular ledge, said second distance being greater than said distance from said annular ledge to said first base region.

5. A fluids collection and drain system as in claim 1, further comprising at least one flexible strap to include a coupler at either end thereof, each said coupler engaging one of said perforations of said perforation region wherein said flexible strap is coupled to said screen.

6. A fluids collection and drain system as in claim 5, wherein each said coupler comprises a capped stud.

7. A fluids collection and drain system as in claim 1, wherein each said support comprises a truncated cone.

8. A fluids collection and drain system as in claim 1, wherein a diameter of said drain port is greater than a diameter of each of said perforations.

9. A fluids collection and drain system, comprising:
a monolithic tray having a base, a peripheral wall to include an annular ledge surrounding said base at a first distance from said base and an annular top surrounding said annular ledge at a second distance from said base greater than said first distance, at least one support coupled to said base wherein said support has a planar top at said distance from said base, and a first drain port and a second drain port defined in opposing sides of said peripheral wall between said base and said annular ledge; and
a monolithic screen having a solid annular frame surrounding a perforation region having a plurality of perforations defined therethrough wherein a diameter of each of said perforations is less than a diameter of said first drain port and a diameter of said second drain port, and wherein said solid annular frame rests on said annular ledge and a portion of said perforation region rests on each said planar top.

10. A fluids collection and drain system as in claim 9, further comprising a plurality of tabs defined in and distributed about said peripheral wall above said annular ledge and below said annular top for engaging said solid annular frame of said screen.

11. A fluids collection and drain system as in claim 9, further comprising:
a first lanyard coupled on one end thereof to an outside edge of said peripheral wall in proximity to said first drain port;
a first cap coupled to another end of said first lanyard wherein said first cap is sized for sealing engagement with said first drain port;
a second lanyard coupled on one end thereof to an outside edge of said peripheral wall in proximity to said second drain port; and
a second cap coupled to another end of said second lanyard wherein said second cap is sized for sealing engagement with said second drain port.

12. A fluids collection and drain system as in claim 9, wherein said base comprises:
a first base region surrounding said at least one support at said first distance from said annular ledge; and
a second base region surrounding said first base region and extending to said peripheral wall, said second base region at a third distance from said annular ledge, said third distance being greater than said first distance.

13. A fluids collection and drain system as in claim 9, further comprising at least one flexible strap to include a coupler at either end thereof, each said coupler engaging one of said perforations of said perforation region wherein said flexible strap is coupled to said screen.

14. A fluids collection and drain system as in claim 13, wherein each said coupler comprises a capped stud.

15. A fluids collection and drain system as in claim 9, wherein each said support comprises a truncated cone.

16. A fluids collection and drain system, comprising:
a monolithic tray having a base, a peripheral wall to include an annular ledge surrounding said base and an annular top surrounding said annular ledge, at least one support coupled to said base wherein said support has a planar top, and at least one drain port defined in said peripheral wall between said base and said annular ledge;
said base having (i) a first base region surrounding said at least one support at a common distance below said annular ledge and each said planar top, and (ii) a second base region surrounding said first base region and extending to said peripheral wall, said second base region being below said first base region and said drain port; and
a monolithic screen having a solid annular frame surrounding a perforation region having a plurality of perforations defined therethrough wherein a diameter of each of said perforations is less than a diameter of said drain port, and wherein said solid annular frame rests on said annular ledge and a portion of said perforation region rests on each said planar top.

17. A fluids collection and drain system as in claim 16, further comprising a plurality of tabs defined in and distributed about said peripheral wall above said annular ledge and below said annular top for engaging said solid annular frame of said screen.

18. A fluids collection and drain system as in claim 16, further comprising:
a flexible lanyard coupled on one end thereof to an outside edge of said peripheral wall; and
a cap coupled to another end of said lanyard wherein said cap is sized for sealing engagement with said drain port.

19. A fluids collection and drain system as in claim 16, further comprising at least one flexible strap to include a coupler at either end thereof, each said coupler engaging one of said perforations of said perforation region wherein said flexible strap is coupled to said screen.

20. A fluids collection and drain system as in claim 19, wherein each said coupler comprises a capped stud.

21. A fluids collection and drain system as in claim 16, wherein each said support comprises a truncated cone.
